(19) United States
(12) Patent Application Publication
(10) Pub. No.: US 2012/0067651 A1
(43) Pub. Date: Mar. 22, 2012

(54) HARDFACING COMPOSITIONS, METHODS OF APPLYING THE HARDFACING COMPOSITIONS, AND TOOLS USING SUCH HARDFACING COMPOSITIONS

(75) Inventors: Sike Xia, Pearland, TX (US); Yong Zhou, Spring, TX (US)

(73) Assignee: Smith International, Inc., Houston, TX (US)

(21) Appl. No.: 13/233,678

(22) Filed: Sep. 15, 2011

Related U.S. Application Data
(60) Provisional application No. 61/383,620, filed on Sep. 16, 2010.

(51) Int. Cl. E21B 10/46; C04B 35/56; B23K 31/02; E21B 10/54; E21B 10/50

(52) U.S. Cl. 175/374; 175/425; 228/101; 501/87

(57) ABSTRACT

A hardfacing composition comprising a carbide phase and a matrix phase, The carbide phase comprises mono-tungsten carbide in a quantity of greater than 50 percent by weight, based on the total weight of the carbide phase. The matrix phase comprises iron and nickel. The nickel is present in a quantity in the range of from 0.5 to 20 percent by weight, based on the total weight of the matrix phase. Also included are methods of applying such hardfacing compositions to a downhole tool and downhole tools having such hardfacing compositions applied thereon.

### CROSS REFERENCE TO RELATED APPLICATIONS

This application claims priority to U.S. Provisional Application Ser. No. 61/383,620, filed Sep. 16, 2010, which is incorporated by reference in its entirety.

### FIELD OF THE INVENTION

The invention relates generally to the field of hardfacing materials used to improve the wear resistance of tools, in particular downhole tools. More particularly, the invention relates to compositions of hardfacing materials which are particularly suitable for use on drill bits.

### BACKGROUND OF THE INVENTION

Hardfacing materials are applied to a variety of downhole tools to improve wear resistance. Hardfacing may be used in an effort to improve both the hardness and fracture toughness of the downhole tool. Composite materials have been applied to the surfaces of downhole tools, in particular drill bits that are subjected to extreme wear. These composite or hard particle materials are often referred to as “hardfacing” materials and typically include at least one phase that exhibits relatively high hardness and another phase that exhibits relatively high fracture toughness. For example, a typical hardfacing material may include tungsten carbide particles substantially randomly dispersed throughout an iron-based matrix material. The tungsten carbide particles exhibit relatively high hardness, while the matrix material exhibits relatively high fracture toughness.

An example of downhole tools which may have hardfacing compositions applied thereon are bits for drilling oil wells. Drill bits used to drill wellbores through earthen formations generally are made within one of two broad categories of bit structures. Drill bits in the first category are generally known as “fixed cutter” or “drag” bits, which usually include a bit body formed from steel or another high strength material and a plurality of cutting elements disposed at selected positions about the bit body. The cutting elements may be formed from any one or combination of hard or ultra hard materials, including, for example, natural or synthetic diamond, boron nitride, and tungsten carbide.

Drill bits of the second category are typically referred to as “roller cone” bits, which include a bit body having one or more legs with roller cones rotatably mounted thereto. The bit body is typically formed from steel or another high strength material and includes a plurality of cutting elements disposed at selected positions about the cones. The cutting elements may be formed from the same base material as the cone. These bits are typically referred to as “milled tooth” bits. Other roller cone bits include “insert” cutting elements that are press (interference) fit into holes formed and/or machined into the roller cones, referred to herein as “insert” roller cone bits. The inserts may be formed from, for example, tungsten carbide, natural or synthetic diamond, boron nitride, or any one or combination of hard or ultra hard materials.

Milled tooth bits include one or more legs having a roller cone rotatably mounted thereto. The roller cones are typically made from steel and include a plurality of teeth formed integrally with the material from which the roller cones are made. Typically, a hardfacing material is applied to the exterior surface of the teeth to improve the wear resistance of the teeth. The hardfacing material typically includes one or more metal carbides, which are bonded to the steel teeth by a metal alloy (“matrix”). Once applied, the carbide particles are in effect suspended in a matrix of metal forming a layer on the surface. In general, the carbide particles give the hardfacing material hardness and wear resistance, while the matrix metal provides fracture toughness to the hardfacing.

Many factors affect the durability of a hardfacing composition in a particular application. These factors include the chemical composition and physical structure (size and shape) of the carbides, the chemical composition and microstructure of the matrix metal or alloy, and the relative proportions of the carbide materials to one another and the matrix metal or alloy.

It is particularly important to provide as much wear resistance and toughness as possible on the teeth of a rock bit cutter cone. Typically, as the wear resistance of the cone is increased, the toughness decreases and vice versa. As used herein, wear resistance is meant to include abrasion resistance and/or erosion resistance.

However, the effective life of the cone is enhanced as wear and fracture resistance of the hardfacing composition is increased. It is desirable to keep the teeth protruding as far as possible from the body of the cone since the rate of penetration of the bit into the rock formation is enhanced by maintaining longer teeth. During use, the teeth get shorter from wear and fracturing of the hardfacing composition. The drill bit is replaced when the rate of penetration decreases to an unacceptable level. Therefore, it is desirable to improve the wear and fracture resistance of the hardfacing composition so that the footage drilled by each bit is maximized. This not only decreases direct cost, but also decreases the frequency of having to “trip” a drill string to replace a worn bit with a new one.

One wear mechanism of the hardfacing material during drilling is abrasion wear. This is typically the dominant wear mechanism on the outer row of teeth on the cutter cone, also referred to as the heel or gage row (other rows of teeth are referred to as “inner rows”). This wear occurs as the teeth rub against the wall or “gage” of the borehole being drilled. Similar abrasion wear occurs on the flank and inner side surfaces of the teeth where drill cuttings run between the teeth.

A hardfacing composition having a low toughness (or fracture resistance) can experience flaking or chipping of the hardfacing material. Flaking or chipping of the hardfacing material on the crest of the teeth of the inner and gage rows can lead to cratering of the hardfacing material which can dramatically reduce the life of the bit. Chipping and flaking of the hardfacing composition results from fracture in the matrix and the carbide particles. Local chipping of the matrix surrounding the carbide particles may result in the dislodging, or pull-out, of the carbide particles which is responsible for cratering in the hardfacing material. Cratering results in a substantial loss of the hardfacing material during drilling which can lead to exposure of the relatively soft base metal of the teeth and subsequent rapid wear. As a result, the drilling efficiency is greatly reduced. Therefore, in addition to improving the wear resistance or hardness of the hardfacing material, it is also important to improve the toughness (or fracture resistance) of the matrix and the carbide particles, especially at the crest of the teeth.

Thus, advances in wear resistance and toughness of hardfacing are desirable to enhance the durability of downhole tools, for example enhancing the footage a drill bit can drill before becoming dull and to enhance the rate of penetration of such drill bits. Such improvements translate directly into a reduction of drilling expenses. The composition of a hardfacing material and microstructure of the hardfacing material applied to the surfaces of a downhole tool, in particular a drill bit, are related to the degree of wear resistance and toughness. It is desirable to have a composition of hardfacing material that, when applied to wear surfaces, provides improved wear resistance and toughness.

### SUMMARY OF THE INVENTION

A hardfacing composition comprising a carbide phase and a matrix phase, The carbide phase comprises mono-tungsten carbide in a quantity of greater than 50 percent by weight, based on the total weight of the carbide phase. The matrix phase comprises iron and nickel. The nickel is present in a quantity in the range of from 0.5 to 20 percent by weight, based on the total weight of the matrix phase. Also included are methods of applying such hardfacing compositions to a downhole tool and downhole tools having such hardfacing compositions applied thereon.

### BRIEF DESCRIPTION OF THE DRAWINGS

FIG. 1 illustrates a milled tooth roller cone drill bit.

FIG. 2 illustrates a cross sectional view of a milled tooth comprising a layer of hardfacing of one or more embodiments of the present disclosure.

FIG. 3 illustrates a fixed cutter drill bit.

FIG. 4 is a plot of ASTM G65 test results.

FIG. 5 is a plot of ASTM B611 test results.

FIG. 6 is a plot of the drop weight impact test results.

### DETAILED DESCRIPTION

In one aspect, embodiments disclosed herein relate to improved hardfacing compositions for a downhole tool. In particular, one or more embodiments disclosed herein relate to hardfacing compositions, methods of manufacturing such hardfacing compositions and downhole tools having such improved hardfacing compositions applied thereon. Such hardfacing compositions exhibit an improved balance of properties such as wear resistance and toughness.

Certain terms are used throughout the following description and claims refer to particular features or components. As one skilled in the art would appreciate, different persons may refer to the same feature or component by different names. This document does not intend to distinguish between components or features that differ in name only. The drawing figures are not necessarily to scale. Certain features and components herein may be shown exaggerated in scale or in somewhat schematic form and some details of conventional elements may not be shown in the interest of clarity and conciseness.

In the following description and in the claims, the terms “including” and “comprising” are used in an open-ended fashion, and thus, should be interpreted to mean “including, but not limited to . . . . ”

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, quantities, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of 1 to 4.5 should be interpreted to include not only the explicitly recited limits of 1 to 4.5, but also include individual numerals such as 2, 3, 4, and sub-ranges such as 1 to 3, 2 to 4, etc. The same principle applies to ranges reciting only one numerical value, such as “at most 4.5”, which should be interpreted to include all of the above-recited values and ranges. Further, such an interpretation should apply regardless of the breadth of the range or the characteristic being described.

As used herein, the mesh sizes refer to standard U.S. ASTM mesh sizes. The mesh size indicates a wire mesh screen with that number of holes per linear inch, for example a “16 mesh” indicates a wire mesh screen with sixteen holes per linear inch, where the holes are defined by the crisscrossing strands of wire in the mesh. The hole size is determined by the number of meshes per inch and the wire size. When using ranges to describe sizes of particles, the lower mesh size denotes (which may also have a “−” sign in front of the mesh size) the size of particles that are capable of passing through an ASTM standard testing sieve of the smaller mesh size and the greater mesh size denotes (which also may have a “+” sign in front of the mesh size) the size of particles that are incapable of passing through an ASTM standard testing sieve of the larger mesh size. For example, particles having sizes in the range of from 16 to 35 mesh (−16/+35 mesh) means that particles are included in this range which are capable of passing through an ASTM No. 16 U.S.A. standard testing sieve, but incapable of passing through an ASTM No. 35 U.S.A. standard testing sieve.

As used herein, the term “cutting structure” is meant to include the elements used to remove the formation such as teeth, inserts and cutter elements and the structure supporting those elements such as the cone, blade, etc.

Hardfacing compositions formed in accordance with the teachings of the present disclosure may be used on other tools in a wide variety of industries and is not limited to downhole tools for the oil and gas industry. The hardfacing compositions of the present disclosure may be applied to the surface of any tool utilized in a downhole application. Downhole tools may include, but are not limited to, drill bits, reamers, hole openers, stabilizers, etc. For purposes of explanation only, a layer of hardfacing formed in accordance with the teachings of the present disclosure are shown on rotary cone drill bits and their associated cutter cone assemblies.

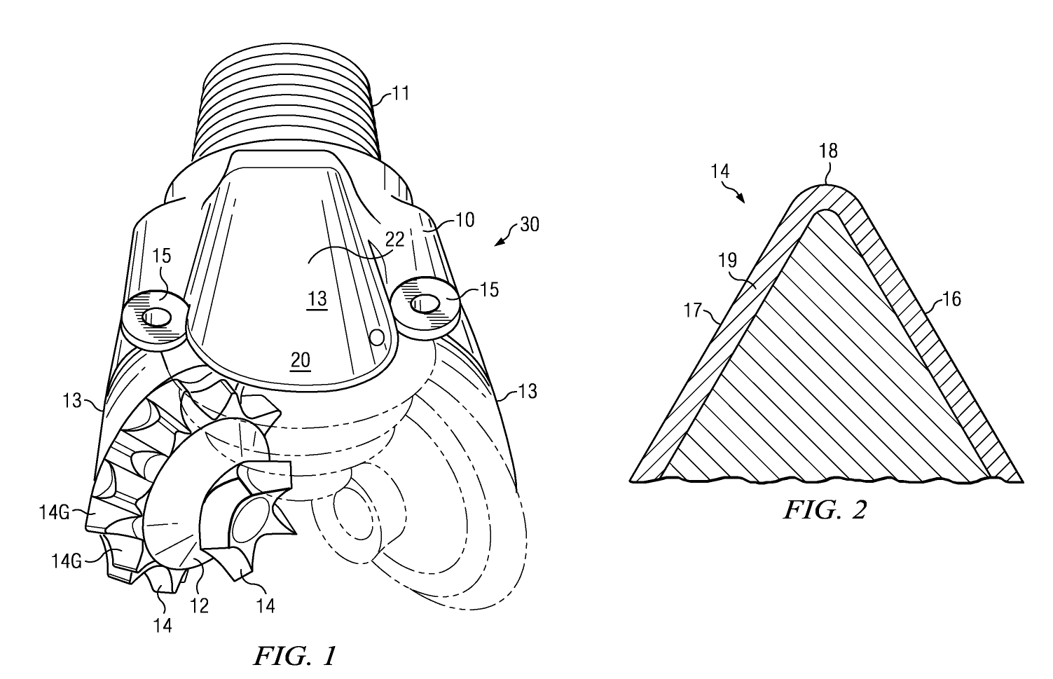

An example of a downhole tool is a milled tooth roller cone drill bit shown in FIG. 1. The milled tooth roller cone drill bit 30 includes a steel body 10 having a threaded coupling (“pin”) 11 at one end for connection to a conventional drill string (not shown). At the opposite end of the drill bit body 10 there is a cutting structure comprising a roller cone 12, for drilling earthen formations to form an oil well or the like (“wellbore”). Each roller cone 12 is rotatably mounted on a journal pin (not shown) extending inwardly on the bit leg 13 which extends downwardly from the upper portion of the bit body 10. Each bit leg 13 has a shirttail region 20 and a leg back face region 22. As the bit is rotated by the drill string (not shown) to which it is attached the roller cones 12 effectively roll on the bottom of the well bore being drilled. The roller cones 12 are shaped and mounted so that as they roll, teeth 14 on the cone 12 gouge, chip, crush, abrade, and/or erode the earthen formations (not shown) at the bottom of the wellbore. The teeth 14G in the row around the heel of the cone 12 are referred to as the “gage row” teeth. They engage the bottom of the hole being drilled near its perimeter or “gage”. Fluid nozzles 15 direct drilling fluid (“mud”) into the hole to carry away the particles of formation created by the drilling.

Such a roller cone drill bit as shown in FIG. 1 is conventional and is therefore merely one example of various arrangements that may be used in a drill bit which is made according to the disclosure. For example, the roller cone drill bit illustrated in FIG. 1 has three roller cones. However, one, two and four roller cone drill bits are also known in the art. Therefore, the number of such roller cones on a drill bit is not intended to be a limitation on the scope of the present disclosure. The arrangement of the teeth 14 on the cones 12 shown in FIG. 1 is just one of many possible variations. In fact, it is typical that the teeth on the three cones on a rock bit differ from each other so that different portions of the bottom of the hole are engaged by each of the three roller cones so that collectively the entire bottom of the hole is drilled. A broad variety of tooth and cone geometries are known and do not form a specific part of this disclosure, nor should the present disclosure be limited in scope by any such arrangement.

The example teeth on the roller cones shown in FIG. 1 are generally triangular in a cross-section taken in a radial plane of the cone. Referring to FIG. 2, such a tooth 14 has a leading flank 16 and a trailing flank 17 meeting in an elongated crest 18. The flanks and crest of the tooth 14 is covered with a hardfacing layer 19. Sometimes only the leading face of each such tooth 14 is covered with a hardfacing layer so that differential erosion between the wear-resistant steel on the trailing face of the tooth tends to keep the crest of the tooth relatively sharp for enhanced penetration of the rock being drilled. The leading flank of the tooth is the face of the tooth that leads the tooth relative to the direction of motion of the cone.

In an example embodiment, although not specifically illustrated herein, the crest of a tooth, that is, the portions facing in more or less an axial direction on the cone, may be the only portion of the teeth provided with a layer of hardfacing. This may be particularly beneficial on the so-called gage row of the bit which is often provided with hardfacing.

In an example embodiment, although not specifically illustrated herein, a hardfacing composition may be applied to one or more of the bit legs 13 to form a layer of hardfacing. The hardfacing may be applied on the shirttail region of the bit legs. The hardfacing may be applied on the leg back face region of the bit legs. Examples of areas of the bit leg that may also be provided with a layer of hardfacing are described in U.S. Patent Publication No. 2007/0163812 A1 (see page 1, paragraphs 5-11); U.S. Patent Publication No. 2006/0283638 A1 (see page 1, paragraphs 7-8 and page 4, paragraphs 38-45); U.S. Patent Publication No. 2008/0223619 (see page 2, paragraphs 29-38); and U.S. Patent Publication No. 2008/0202817 A1 (see page 2, paragraphs 19-21), which are each incorporated by reference.

While the present disclosure has been described with respect to a limited number of embodiments, one of ordinary skill in the art would also recognize that any exterior surface of a drill bit may be provided with a layer of hardfacing.

The inner row teeth 14 work under very high and complex stresses when crushing, gouging, and scraping the earthen formation while drilling the well. These complex stresses in combination with the heat generated by the work of the teeth on the earthen formation, especially at the crest of the teeth, tend to cause the initiation of fatigue cracks in the steel matrix of the hardfacing and subsequent loss of the hardfacing due to gross fracture and chipping. One way of enhancing the strength of the hardfacing is to increase the toughness of the matrix material and improve the wear resistance and toughness of the carbide particles contained within the hardfacing. However, generally as the wear resistance or hardness of the hardfacing composition increases there is a trade-off in toughness or fracture resistance.

Without wishing to be bound by theory, it is believed that the presence of eta phase and oxide particles in the matrix formed during application of the hardfacing reduces the toughness of the matrix (i.e., the matrix becomes more brittle). Eta phase (e.g., (WFe)₆C and (WCo)₆C) and oxide particles form in the matrix material during hardfacing application. Excessive heat, which enhances element diffusion and chemical reaction kinetics, increases the eta and/or oxide content. The eta phase and oxides are brittle compounds. Thus, a matrix containing a large portion of eta phase and/or oxide particles tends to be brittle and more prone to fracture.

When a hardfacing material is applied to a surface of a drill bit, relatively high temperatures are used to melt the matrix material. Without wishing to be bound by theory, it is believed that at these relatively high temperatures, dissolution may occur between the carbide particles, especially sintered metal carbide particles, and the matrix material (e.g., iron-based alloy). In other words, during the application of the hardfacing material, the melted iron in the matrix material can diffuse into the carbide particles, especially the sintered metal carbide particles, and the metal binder of sintered metal carbide particles can also diffuse out of the sintered metal carbide particles into the matrix material. However, sintered metal carbide particles are typically used in hardfacing materials for imparting improved toughness properties to the hardfacing as compared to cast carbide and stoichiometric carbides (e.g., mono-tungsten carbide). When the hardfacing material includes sintered metal carbide particles of tungsten carbide cobalt, dissolution may be great as the cobalt metal binder of the sintered carbide particles has a lower melting temperature than the iron-based alloy of the matrix material. The rate of dissolution increases with increasing temperature and increasing time of exposure of the hardfacing to heat. For example, an iron-based matrix material will have greater dissolution of sintered tungsten carbide cobalt particles than a nickel-based matrix material will, because of the higher temperatures and longer heating times required to bring the iron-based matrix material into a molten state during application. However, iron-based matrix materials are typically preferred over nickel-based matrix materials in hardfacing of teeth of mill-tooth bits because iron-based materials provide improved strength. Thus, utilizing an iron-based matrix material provides unique challenges to minimize dissolution. Dissolution can significantly reduce the density of carbide particles which can lead to a reduction in wear resistance. In particular, some sintered metal carbide particles may be completely dissolved. In addition, metal binder diffusing from sintered metal carbide particles into the matrix material provides metal atoms for eta phase formation which can lead to reduced toughness.

It has been found that the dissolution of the carbide particles and formation of eta phase and oxide particles in the iron-based matrix material can be minimized by using hardfacing compositions in accordance with the teachings of the present disclosure. The hardfacing compositions according to embodiments of the present disclosure have unexpectedly good performance properties of wear resistance and toughness, which properties are typically inversely related (i.e., as the wear resistance increases the toughness decreases and vice versa).

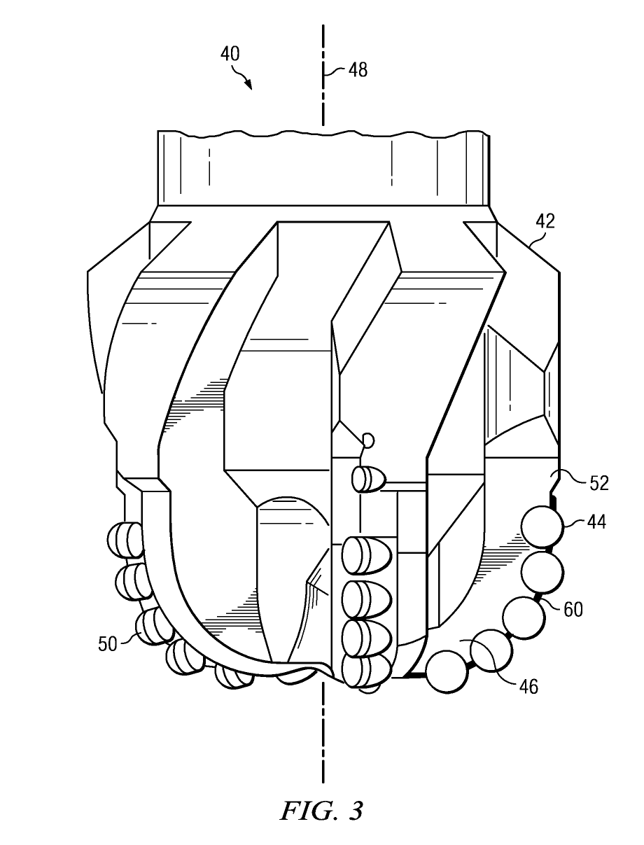

Another example of a downhole tool is a fixed cutter drill bit shown in FIG. 3. In this example, as shown in FIG. 3, a fixed cutter drill bit 40 includes a bit body 42, which includes a cutting structure comprising at least one blade and at least one polycrystalline diamond compact (PDC) cutter element 44 disposed thereon. Typically, the bit body may be formed of steel or a matrix material. The matrix material may be formed from a powdered tungsten carbide infiltrated with an infiltration binder alloy within a suitable mold form. The bit body 42 is formed with at least one blade 46, which extends generally outward away from a central longitudinal axis 48 of the drill bit 40. In this example, the bit body may include one or more layers of hardfacing 60 for abrasion and/or erosion resistance. The PDC cutter element 44 is disposed on the blade 46. The blade 46 includes at least one cutter pocket 50 which is adapted to receive the PDC cutter element 44, and the PDC cutter element 44 is usually brazed into the cutter pocket 50. The area of the blade 46 that contacts the wall of the wellbore (not shown separately) is the gage area 52. The number of blades 46 and/or PDC cutter elements 44 are related, among other factors, to the type of formation to be drilled, and can thus be varied to meet particular drilling requirements. The PDC cutter element 44 may be formed from a sintered tungsten carbide composite substrate and a polycrystalline diamond layer or table, among other materials. The polycrystalline diamond layer and the sintered tungsten carbide substrate may be bonded together using any method known in the art. The one or more layers of hardfacing may be deposited on any exterior surface of the fixed cutter drill bit. In some example embodiments, the hardfacing may be deposited on at least a portion of a blade of the fixed cutter drill bit which may include at least a portion of the cutter pocket. In other example embodiments, the hardfacing layer may be deposited on the gage area of the fixed cutter drill bit. Additional description relating to locations of a fixed cutter drill bit having hardfacing deposited thereon may be found in U.S. Patent Publication No. 2008/0083568 A1 (see page 3, paragraph 32 through page 4, paragraph 47) and U.S. Patent Publication No. 2008/0053709 A1 (see page 2 paragraph 15 through page 3, paragraph 34 and page 3, paragraph 41 through page 4, paragraph 51), which are each incorporated herein by reference in their entirety.

A hardfacing layer may be applied to the surface of the downhole tool (e.g., drill bit) by providing a tool and a hardfacing composition, applying the hardfacing composition by heating such that the metal matrix material melts, and allowing the molten metal matrix material to solidify. There are various welding techniques known in the art for depositing hardfacing, for example oxyacetylene welding process (OXY), plasma transferred arc (PTA), an atomic hydrogen welding (ATW), welding via tungsten inert gas (TIG), gas tungsten arc welding (GTAW), and other applicable processes. Of particular concern are the high temperatures and exposure times used in the application of hardfacing compositions containing iron-based matrix alloys due to the high melting temperatures of iron-based matrix alloys. Oxyacetylene processes can be especially of concern due to the excessive heating and exposure times. When the surface on which the hardfacing composition is to be applied has a complicated geometry (e.g., the cones and/or teeth of a roller cone drill bit or the cutting structure of a fixed cutter drill bit), an oxyacetylene welding process is particularly suitable. In oxyacetylene welding, the hardfacing material is typically supplied in the form of an outer tube or hollow rod (“a welding rod”), which is filled with granular material (a “filler material”) of a certain composition. The outer tube is usually made of steel or other iron-based metal which can act as a matrix material when the rod and its granular filler contents are heated. The tube thickness may be selected so that its metal forms a selected fraction of the total composition of the hardfacing material (before application to the drill bit). Alternatively, the iron-based binder alloy may be in the form of an inner wire (“a welding wire”) and the filler materials are coated on the wire using resin binders or all the components may be in the form of a powder.

Embodiments of the present disclosure relate to compositions of hardfacing materials for application to downhole tools such as drill bits. The hardfacing compositions of the present disclosure comprise a carbide phase and a matrix phase. As used herein, the term “carbide phase”, is meant to include the wear resistant materials, such as the carbide particles as described herein, which for example may be placed within a welding rod or which may be placed upon a welding wire forming at least a portion of the filler material. As used herein, the term “matrix phase” is meant to include materials other than those in the carbide phase.

The matrix phase may comprise iron and nickel. The iron may be present as an iron-based alloy (i.e., iron forming the greatest weight percentage in the alloy). In an embodiment, iron-based alloys may include soft steels. As used herein, the term “soft steel” is meant to include steel materials which have a low carbon content, for example steel having a carbon content of less than 0.15% by weight, based on the total weight of the steel (i.e., mild steel). Examples of mild steel include, but are not limited to, AISI (American Iron and Steel Institute) 1010 (0.1% w carbon), AISI 1008 (0.08% w carbon), and AISI 1006 (0.06% w carbon) grades of steel. Although a mild steel sheet may be used when forming the outer tubes of a welding rod or the inner wire of the welding wire, the steel in the hardfacing as applied to a tool is a hard, wear resistant, alloy steel. This occurs through the mixing of other elements with the mild steel during welding. In this embodiment, nickel may be present in the filler material as elemental nickel metal or a nickel-containing alloy. In one or more embodiments, the nickel-containing alloy may be selected from a nickel-boron-silicon alloy, a nickel-iron alloy (more nickel by weight than iron), an iron-nickel alloy (more iron by weight than nickel), and combinations thereof. In another embodiment, the iron and nickel may be present as an iron-nickel alloy which may be used to form the outer tube of a welding rod or an inner wire of a welding wire. The embodiments described herein may refer to a welding rod or welding wire, however, it is understood that similar compositions may be used where both the carbide phase and matrix phase may be provided in powder form, for example when using a PTA welding technique.

The matrix phase may contain nickel in a quantity in the range of from 0.5 to 20 percent by weight (% w), based on the weight of elemental nickel in the total weight of the matrix phase. Suitably, nickel may be present in the matrix phase in a quantity in the range of from 1 to 15% w or 5 to 10% w, for example, 2.5% w, 7.5% w, 12.5% w, or 17.5% w, same basis. All percentages given herein are pre-application percentages unless specified to the contrary.

The matrix phase may contain iron in a quantity in the range of from 50 to 99.5 percent by weight (% w), based on the weight of elemental iron in the total weight of the matrix phase. Suitably, iron may be present in the matrix phase in a quantity in the range of from 60 to 95% w or 70 to 90% w, for example, 55% w, 65% w, 75% w, 80% w, or 85% w same basis.

The matrix phase may also contain one or more additional metals. Examples of additional metals include manganese and silicon.

In one or more embodiments, the matrix phase may comprise chromium in a quantity of at most 1% by weight, based on the weight of elemental chromium in the total weight of the matrix phase, for example at most 0.5% w or at most 0.2% w, or the matrix phase may be substantially free of chromium.

In an embodiment, the nickel may be present in the outer tube or inner wire as an alloy containing iron and nickel. In other embodiments, the nickel may additionally or alternatively be present in the filler material. In particular, the nickel (e.g., elemental nickel metal, a nickel-boron-silicon alloy, a nickel-iron alloy (more nickel by weight than iron), an iron-nickel alloy (more iron by weight than nickel), and mixtures thereof) may be present as a powder (particles) in the filler material or as a coating applied to at least a portion of the carbide particles in the filler material. Preferably, the nickel may be present as a powder which reduces the complexity of the manufacturing process.

In an embodiment, the iron may be present in the outer tube or inner wire as an alloy as described above. The outer tube or inner wire may contain an iron alloy, such as soft steels, which do not contain nickel. Alternatively, the outer tube or inner wire may contain an iron-nickel alloy. In other embodiments, the iron may additionally be present in the filler material. In particular, the iron (iron alloys as described above) may be present as a powder (particles) in the filler material or as a coating applied to at least a portion of the carbide particles in the filler material.

The carbide phase may be present in a quantity of at least 50% by weight, based on the total weight of the hardfacing composition or greater than 60% by weight, same basis. Suitably, the carbide phase may be present in a quantity in the range of from 50% to 75% by weight, based on the total weight of the hardfacing composition, in particular from 55% w to 70% w, more in particular from 60% w to 70% w, for example 67% w, on the same basis. The matrix phase may be present in a quantity of from 10% to 50% by weight, based on the total weight of the hardfacing composition, in particular from 25% w to 45% w, more in particular from 30% w to 40% w, for example 33% w, on the same basis. The proportions can be controlled, for example, by using outer tubes or inner wires of different thickness and diameter. For example to obtain a 70% w carbide phase and 30% w matrix phase, a 5/32 inch (4 mm) diameter tube is made with an iron-nickel alloy having a wall thickness of 0.017 inch (0.43 mm). Alternatively, a 3/16 inch (4.5 mm) diameter tube with a wall 0.02 inch (0.5 mm) thick will produce roughly the same weight ratio.

The matrix phase may also comprise a deoxidizer. A suitable deoxidizer may include a silicomanganese composition which may be obtained from Chemalloy in Bryn Mawr, Pa. A suitable silicomanganese composition may contain 65% w to 68% w manganese, 15% w to 18% w silicon, a maximum of 2% w carbon, a maximum of 0.05% w sulfur, a maximum of 0.35% w phosphorus, and a balance comprising iron. Suitably, the deoxidizer may be present in a quantity of at most 15% w, based on the total weight of the matrix phase, for example about 3% w to about 10% w, on the same basis, may be used. Suitably, the deoxidizer may be provided as a powder in the filler material.

The matrix phase may also comprise niobium. Additional description relating to niobium in hardfacing compositions may be found in U.S. Pat. No. 4,414,029 (see column 2, lines 58 through column 3, line 3) and U.S. Pat. No. 6,248,149 (see column 4, lines 57 through 65), which are each incorporated herein by reference in their entirety. The niobium may be present in a quantity of at most 5% w, based on the total weight of the matrix phase, for example at most 2.5% w or at most 1% w, same basis. Suitably, the niobium may be provided as a powder in the filler material.

The filler material may comprise a temporary resin binder. A small quantity of thermoset resin is desirable for partially holding the particles in the filler material (e.g., carbide phase) together so that they do not shift during application, e.g., welding. Suitably, the resin binder may be present in a quantity of at most 1% w, based on the total weight of the hardfacing composition, for example at most 0.5% w, on the same basis may be adequate. The term, “deoxidizer”, as used herein, refers generally to deoxidizer with or without the resin. Suitably, the deoxidizer/resin binder will form no more than about 5% w, preferably at most 4% w, based on the total weight of the matrix phase.

The hardfacing composition comprises mono-tungsten carbide. The metal carbide most commonly used in hardfacing is tungsten carbide. Many different types of tungsten carbides are known based on their different chemical compositions and physical structure. Three types of tungsten carbide commonly used in hardfacing drill bits are mono-tungsten carbide, cast tungsten carbide, and sintered tungsten carbide (also known as cemented tungsten carbide).Tungsten generally forms two carbides, mono-tungsten carbide (WC) and ditungsten carbide (W₂C). Cast carbide is a eutectic mixture of the WC and W₂C compounds, as such the carbon content in cast carbide is sub-stoichiometric, (i.e., it has less carbon than the mono-tungsten carbide). Cast carbide is typically made by resistance heating tungsten in contact with carbon in a graphite crucible having a hole through which the resultant eutectic mixture drips. The liquid is quenched in a bath of oil and is subsequently comminuted to the desired particle size and shape.

Mono-tungsten carbide is essentially stoichiometric tungsten carbide (WC). Mono-tungsten carbide may be selected from macro-crystalline tungsten carbide and carburized tungsten carbide. Carburized mono-tungsten carbide may be fully carburized or partially carburized (i.e., a core of cast tungsten carbide and a shell of carburized mono-tungsten carbide). Mono-tungsten carbide may be angular or spherical in shape, suitably angular. The term “spherical”, as used herein and throughout the present disclosure, means any particle having a generally spherical shape and may not be true spheres, but lack the corners, sharp edges, and angular projections commonly found in crushed and other non-spherical particles. The term, “angular”, as used herein in the present disclosure, means any particle having corners, sharp edges and angular projections commonly found in non-spherical particles.

One type of mono-tungsten carbide is macro-crystalline tungsten carbide. Macro-crystalline tungsten carbide may be formed using a high temperature thermite process during which ore concentrate is converted directly to mono-tungsten carbide. Such methods of manufacturing macrocrystalline tungsten carbide are described in U.S. Pat. Nos. 3,379,503 and 4,834,936, which are incorporated by reference herein in their entirety.

Another type of mono-tungsten carbide is fully carburized tungsten carbide which is typically multicrystalline in form, i.e., composed of tungsten carbide agglomerates. Fully carburized tungsten carbide may be formed using a carburization process where solid-state diffusion of carbon into tungsten metal occurs to produce mono-tungsten carbide. Typical fully carburized mono-tungsten carbide contains a minimum of 99.8% by weight of tungsten carbide with a total carbon content in the range of from about 6.08% to about 6.18% by weight, preferably about 6.13% by weight, based on the weight of tungsten carbide.

Another type of carburized tungsten carbide is partially carburized tungsten carbide particles having a core (or inner region) of cast tungsten carbide and a shell (or outer region) of mono-tungsten carbide. Such mono-tungsten carbide particles are described in U.S. Patent Publication No. 2007/0079905, which is incorporated by reference in its entirety (see page 1, paragraph 13 through page 3, paragraph 33). Such partially carburized mono-tungsten carbide particles may have a bound carbon content in the range of from 4% w to 6% w, based on the total weight of the particle, in particular from 4.5% w to 5.5% w, more in particular 4.3% w, to 4.8% w, on the same basis. The free carbon content of such mono-tungsten carbide particles may be at most 0.1% w, on the same basis. Such mono-tungsten carbide particles may be made using a carburization process wherein cast tungsten carbide powder is heated in the presence of a carbon source to a temperature of 1300 to 2000° C., preferably 1400 to 1700° C.

The mono-tungsten carbide is present in a quantity of greater than 50% w, based on the total weight of the carbide phase. Suitably, the mono-tungsten carbide may be present in a quantity in the range of from 55 to 100% w or 55 to 95% w, for example 60% w, 65% w, 70% w, 75% w , or 80% w, same basis.

In one or more embodiments, the majority (i.e., greater than 50% w, based on the total weight of mono-tungsten carbide) of mono-tungsten carbide may be macrocrystalline mono-tungsten carbide, for example substantially all the mono-tungsten carbide present in the carbide phase may be macrocrystalline mono-tungsten carbide.

In one or more embodiments, the majority (i.e., greater than 50% w, based on the total weight of mono-tungsten carbide) of mono-tungsten carbide may be partially carburized mono-tungsten carbide having a core of cast tungsten carbide and a shell of mono-tungsten carbide, for example substantially all the mono-tungsten carbide present in the carbide phase may be partially carburized mono-tungsten carbide.

In one or more embodiments, the mono-tungsten carbide may comprise macrocrystalline mono-tungsten carbide and partially carburized mono-tungsten carbide having a core of cast tungsten carbide and a shell of mono-tungsten carbide. In an embodiment, the macrocrystalline mono-tungsten carbide and the partially carburized mono-tungsten carbide may be present in a weight ratio of 1:1.

The mono-tungsten carbide may have a particle size distribution that is mono-modal or multi-modal, for example bi-modal, tri-modal, etc. The mono-tungsten carbide may have a particle size distribution having mono-tungsten carbide particles having sizes in the range of from 40 to 325 mesh (approximately 40 to 400 micrometers (microns)), for example in the range of from 60 to 200 mesh (−60/+200 mesh) (approximately 75 to 250 microns).

The carbide phase may also comprise additional carbide components. The additional carbide components may be selected from sintered metal carbide, cast tungsten carbide, and other metal carbides such as chromium carbide, molybdenum carbide, niobium carbide, tantalum carbide, titanium carbide, vanadium carbide, and mixtures thereof. The carbide phase may also comprise ultra-hard components such as polycrystalline diamond and polycrystalline boron nitride.

Sintered metal carbide comprises a metal carbide and a metal binder. The metal carbide particles are sintered together in the presence of a metal binder. The metal carbide may be selected from tungsten carbide, chromium carbide, molybdenum carbide, niobium carbide, tantalum carbide, titanium carbide, vanadium carbide, and mixtures thereof, in particular tungsten carbide. The metal binder may include Group VIII elements of the Periodic Table (CAS version of the Periodic Table found in the CRC Handbook of Chemistry and Physics, inside cover), in particular cobalt, nickel, iron, mixtures thereof, and alloys thereof. Preferably, the metal binder comprises cobalt. The sintered carbide may be in the form of angular particles or spherical particles (i.e., pellets), suitably spherical particles. The sintered metal carbide may be a super dense sintered metal carbide. The term “super dense sintered carbide”, as used herein, includes the class of sintered particles as disclosed in U.S. Patent Publication No. 2003/0000339, the disclosure of which is incorporated herein by reference (page 2, paragraph 19 through page 3, paragraph 47). Such super dense sintered carbide particles are typically of substantially spheroidal shape (i.e., pellets) and have a predominantly closed porosity or are free of pores. The process for producing such particles starts from a powder material with a partially porous internal structure, which is introduced into a furnace and sintered at a temperature at which the material of the metal binder adopts a pasty state while applying pressure to reduce the pore content of the starting material to obtain a final density.

Sintered tungsten carbide comprises small particles of tungsten carbide (e.g., 1 to 15 microns) bonded together with a metal binder such as cobalt. Sintered tungsten carbide may be produced by mixing an organic wax, mono-tungsten carbide and metal binder; pressing the mixture to form a green compact; sintering the green compact at temperatures near the melting point of the metal binder; and comminuting the resulting sintered compact to form particles of the desired particle size and shape. The sintered tungsten carbide may be further processed to form super dense tungsten carbide as discussed above.

In one or more embodiments, the carbide phase may further comprise sintered tungsten carbide. The sintered tungsten carbide may be present in a quantity in the range of from 5 to 49% w, based on the total weight of the carbide phase for example in the range of from 30 to 45% w, based on the total weight of the carbide phase, such as 32.5% w, 35% w, 37.5% w, 40% w, or 42.5% w, same basis. The sintered tungsten carbide may have a mono-modal or multi-modal (e.g., bi-modal, tri-modal, etc.) particle size distribution. The particles of sintered tungsten carbide may have sizes in the range of from 12 to 200 mesh (−12/+200 mesh) (approximately 75 to 1700 microns). Suitably, the particles of sintered tungsten carbide may have sizes in the range of from 16 to 40 mesh (−16/+40 mesh) (approximately 400 to 1200 microns).

In one or more embodiments, the sintered tungsten carbide may comprise a first quantity of particles having sizes in the range of from 30 to 40 mesh (−30/+40 mesh) (approximately 400 to 600 microns). Additionally, the sintered tungsten carbide may further comprise a second quantity of particles having sizes in the range of from 16 to 20 mesh (−16/+20 mesh) (approximately 850 to 1200 microns). The sintered tungsten carbide may be at least bi-modal. The second quantity of particles which have sizes in the range of from 16 to 20 mesh may be present in a quantity of greater than 50% w, based on the total weight of the sintered tungsten carbide in the hardfacing composition, for example in the range of from 55 to 75% w or 55 to 65% w, same basis.

In one or more embodiments, the hardfacing composition (post-application) has a wear rate of less than 0.003 cc/1000 revolutions (rev), as measured by the ASTM G65 test method, for example at most 0.00275, or at most 0.0025, or at most 0.002 cc/1000 rev. In one or more embodiments, the hardfacing composition (post-application) has a high stress wear rate of at most 0.5 cc/1000 rev, as measured by the ASTM B611 test method, for example at most 0.475, or at most 0.45, or at most 0.4, or at most 0.38 cc/1000 rev.

In these and other embodiments of the present disclosure, it is understood that the particle size distribution within the mesh ranges disclosed may be mono- or multi-modal.

After application of the hardfacing composition (post-application), the thickness of the hardfacing layer may be any thickness, suitably in the range of from about 0.06 inch (1.5 mm) to less than about 0.18 inch (4.6 mm). The carbide content in the applied hardfacing layer can be determined by metallographic examination of a cross section through the hardfacing. The areas of the carbide and matrix phases can be determined. From this, the volume percentages of matrix and carbide can be determined, and in turn the weight percentages for the applied hardfacing composition.

The hardfacing composition of the present disclosure provides a material which has both improved wear resistance and toughness. Such properties are especially important when the hardfacing is applied to the inserts or teeth of a rotatable cone of a roller cone drill bit which actively engage the earthen formation through gouging and crushing the formation as compared to other surface locations which do not actively engage the earthen formation but prevent wear and erosion of the surface upon which it is applied. Without wishing to be bound by theory, it is believed that the combination of high amounts of mono-tungsten carbide in the carbide phase and a small amount of nickel in the matrix phase provides a hardfacing composition with reduced amounts of eta phase, oxides and dissolution of particles in the carbide phase which is believed to improve the properties of the hardfacing composition. Also, it is believed that the small amount of nickel present in the matrix phase reduces the porosity and micro-cracks in the hardfacing composition which as a result improves the strength of the matrix phase. The addition of the small amount of nickel also unexpectedly improves the toughness of the matrix phase without significantly affecting the strength typically associated with a steel matrix phase.

### EXAMPLES

The following examples illustrate the improved properties of one or more embodiments of the present disclosure. “Composition A” and “Composition B” hardfacing compositions were prepared according to one or more embodiments of the present disclosure and demonstrate improved performance compared to comparative “Composition C”; comparative “Composition D; comparative “Composition E”; and comparative “Composition F”. The compositions of each are described further below in Table I.

TABLE I
Filler Material Contents

| | | | | | Sintered | Sintered | | | | | |
|---|---|---|---|---|---|---|---|---|---|---|---|
| | | | | | tungsten | tungsten | Cast | Cast | | | |
| | Mono- | Mono- | Mono- | Mono- | carbide- | carbide- | tungsten | tungsten | Nickel | | |
| | tungsten | tungsten | tungsten | tungsten | cobalt⁴ | cobalt⁴ | carbide | carbide | metal | Niobium | |
| | carbide | carbide | carbide | carbide | (% w) | (% w) | (% w) | (% w) | powder | metal | |
| | (% w) | (% w) | (% w) | (% w) | (−16/+20 | (−30/+40 | (−40/+60 | (−40/+80 | (% w) | (% w) | Deoxidizer + |
| | (−80/+200 | (−60/+140 | (−325 | (−80/+270 | mesh) | mesh) | mesh) | mesh) | (−325 | (−325 | binder |
| Composition | mesh) | mesh) | mesh) | mesh) | spherical | spherical | angular | angular | mesh) | mesh) | (% w) |
| A | 27¹ | 28¹ | — | — | — | 37 | — | — | 3 | 0.35 | 4.65 |
| B | 27¹ | 28¹ | — | — | 23 | 14 | — | — | 3 | 0.35 | 4.65 |
| C | — | — | 10³ | — | 35 | 24 | 27 | — | — | 0.35 | 3.65 |
| D | — | — | 10³ | — | 40 | 28 | — | 18 | — | 0.35 | 3.65 |
| E | — | 47² | — | 48² | — | — | — | — | — | — | 5 |
| F | 95¹ | — | — | — | — | — | — | — | — | — | 5 |

¹the mono-tungsten carbide is provided as angular macro-crystalline mono-tungsten carbide
²the mono-tungsten carbide is provided as angular partially carburized mono-tungsten carbide having a core of cast tungsten carbide and shell of mono-tungsten carbide
³the mono-tungsten carbide is provided as angular fully carburized mono-tungsten carbide
⁴the sintered tungsten carbide-cobalt was non-super dense sintered tungsten carbide-cobalt

The weight percentages provided in Table I are the weight percentages pre-application and based on the total weight of the filler material. The filler material comprised 67-70% w, based on the total weight of the hardfacing composition pre-application. The filler material was placed in an outer tube of AISI 1008 mild steel. The outer tube comprised 30-33% w, based on the total weight of the hardfacing composition pre-application.

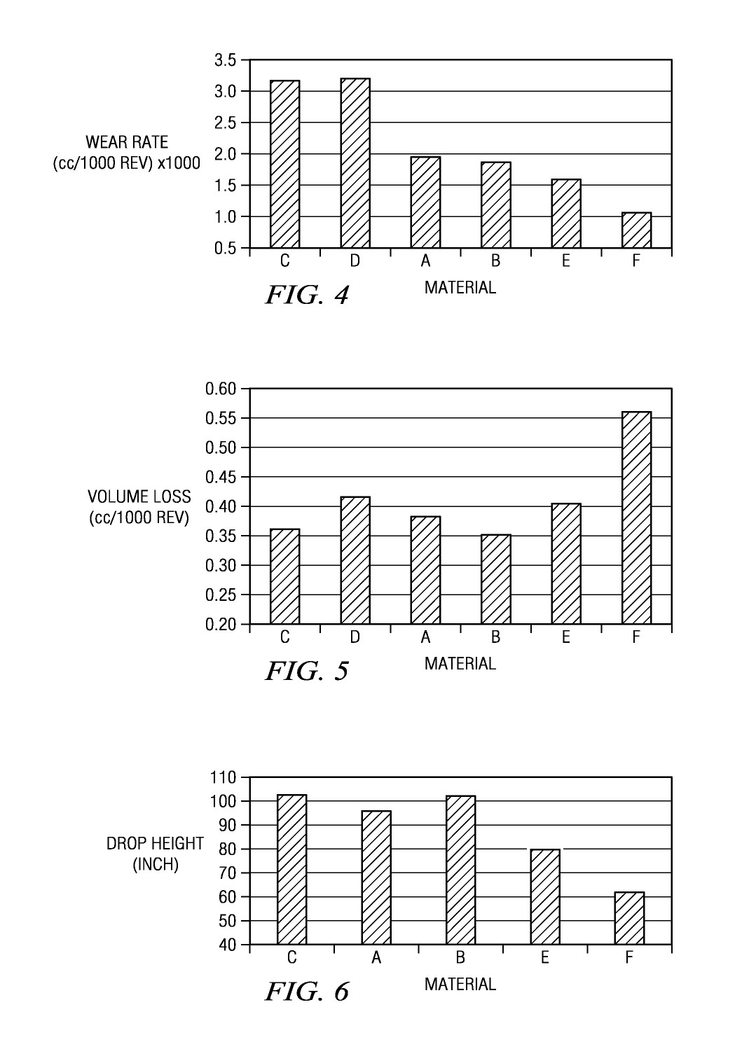

Coupon samples were hardfaced with Compositions A-F using a welding rod as described above. The hardfacing composition was applied using an oxyacetylene welding process. Samples of Compositions A-F were then subjected to a wear test according to the ASTM G65 protocols, which provide an indication of the wear resistance. This test was run again on fresh coupon samples of Compositions A-F. The averages of the two tests for each of the Compositions A-F are plotted in FIG. 4. A lower value for wear rate indicates better performance.

Additional samples of Compositions A-F were also subjected to a high stress wear test according to the ASTM B611 protocols, which provide an indication of the wear resistance and toughness. This test was run again on fresh coupon samples of Compositions A-F. The averages of the two tests for each of the Compositions A-F are plotted in FIG. 5. A lower value for volume loss indicates better performance.

Tooth samples of Compositions A-C and E-F were also subjected to a drop weight impact test, which provide an indication of the toughness. This test was run again on tooth samples of Compositions A-C and E-F. The averages of the two tests for each of the Compositions A-C and E-F are plotted in FIG. 6. The greater drop height indicates better performance. The drop height impact test used a cylindrical weight (weighing 12 pounds and having an outer diameter of 1.5 inches and a length of 2 feet) which was placed within a PVC outer tube with a pin mechanism to hold the weight at the desired height and a release mechanism was used to withdraw the pin allowing the weight to drop from the desired height and impact the test sample positioned beneath the weight. An initial height of 36 inches was used for the first drop height. The weight was raised so that the bottom of the weight was positioned 36 inches above the test sample and a pin engaged to hold the weight within the PVC tube at the height. The pin was then released and the weight allowed to drop impacting the test sample placed beneath it. Once the weight came to rest, the test sample was examined for spalling. If there was no observed spalling, the height of the weight was increased by 6 inches and the weight was allowed to impact the sample again. This was repeated (increasing the height 6 inches with each subsequent drop) until spalling was observed or a maximum height of 102 inches was achieved without spalling being observed. Once spalling was observed or 102 inch drop height was achieved, the drop height for the sample was recorded.

The test results demonstrate that Compositions A and B unexpectedly show an improvement in hardness/wear resistance without sacrificing toughness as compared to comparative Compositions C-F.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A hardfacing composition comprising:
A carbide phase comprising mono-tungsten carbide in a quantity of greater than 50% by weight, based on the total weight of the carbide phase; and
A matrix phase comprising iron and nickel, wherein nickel is present in a quantity in the range of from 0.5 to 20% by weight, based on the total weight of the matrix phase.

2. The hardfacing composition of claim 1, wherein the mono-tungsten carbide comprises macrocrystalline mono-tungsten carbide.

3. The hardfacing composition of claim 1, wherein the mono-tungsten carbide comprises substantially all macrocrystalline mono-tungsten carbide.

4. The hardfacing composition of claim 1, wherein the mono-tungsten carbide comprises particles having a core of cast tungsten carbide and a shell of mono-tungsten carbide.

5. The hardfacing composition of claim 4, wherein the mono-tungsten carbide comprises substantially all particles having a core of cast tungsten carbide and a shell of mono-tungsten carbide.

6. The hardfacing of claim 2, wherein the mono-tungsten carbide further comprises particles having a core of cast tungsten carbide and a shell of mono-tungsten carbide.

7. The hardfacing of claim 6, wherein the macrocystalline mono-tungsten carbide is present in a weight ratio of 1:1 with the additional mono-tungsten carbide.

8. The hardfacing composition of claim 1, wherein the mono-tungsten carbide is present in a quantity in the range of from 55 to 95% by weight, based on the total weight of the carbide phase.

9. The hardfacing composition of claim 1, wherein the mono-tungsten carbide comprises angular particles.

10. The hardfacing composition of claim 1, wherein the mono-tungsten carbide has a particle size distribution in the range of from 40 to 325 mesh.

11. The hardfacing composition of claim 1, wherein the mono-tungsten carbide has a bi-modal particle size distribution.

12. The hardfacing composition of claim 1, wherein nickel is present in a quantity in the range of from 1 to 15% by weight, based on the total weight of the matrix phase.

13. The hardfacing composition of claim 1, wherein nickel is present in a quantity in the range of from 5 to 10% by weight, based on the total weight of the matrix phase.

14. The hardfacing composition of claim 1, wherein the carbide phase further comprises sintered tungsten carbide.

15. The hardfacing composition of claim 14, wherein the sintered tungsten carbide is spherical and is present in a quantity in the range of from 5 to 49% by weight, based on the total weight of the carbide phase and has a particle size distribution ranging from 12 to 200 mesh.

16. The hardfacing composition of claim 15, wherein the sintered tungsten carbide has a bi-modal particle size distribution and further comprises sintered tungsten carbide with a particle size ranging from 16 to 20 mesh.

17. The hardfacing composition of claim 16, wherein the sintered tungsten carbide having a particle size ranging from 16 to 20 mesh comprises greater than 50% by weight of the total weight of sintered tungsten carbide present in the hardfacing composition.

18. A downhole tool comprising a tool body and a hardfacing composition applied to a surface thereon, wherein the hardfacing composition comprises:
A carbide phase comprising mono-tungsten carbide in a quantity of greater than 50% by weight, based on the total weight of the carbide phase; and
A matrix phase comprising iron and nickel, wherein nickel is present in a quantity in the range of from 0.5 to 20% by weight, based on the total weight of the matrix phase.

19. The downhole tool of claim 18, wherein the downhole tool is a fixed cutter drill bit and the tool body comprises a plurality of blades and at least one cutting element attached thereto.

20. The downhole tool of claim 18 wherein the downhole tool is a rolling cone drill bit and the tool body comprises a plurality of legs and a rotatable cone attached thereto.

21. The downhole tool of claim 20, wherein the hardfacing composition is applied to a shirttail region of at least one of the plurality of legs.

22. The downhole tool of claim 20, wherein the hardfacing composition is applied to a leg backface region of at least one of the plurality of legs.

23. A method of applying a hardfacing composition to a downhole tool comprising:
Providing a hardfacing composition comprising:
A carbide phase comprising mono-tungsten carbide in a quantity of greater than 50% by weight, based on the total weight of the carbide phase; and
A matrix phase comprising iron and nickel, wherein nickel is present in a quantity in the range of from 0.5 to 20% by weight, based on the total weight of the matrix phase; and
Applying the hardfacing composition to a surface of the downhole tool.

24. The method of claim 23, wherein the hardfacing composition is provided in the form of a welding rod comprising a filler material positioned within an outer tube, wherein the filler material comprises the carbide phase and a nickel powder.

25. The method of claim 23, wherein the hardfacing is applied utilizing an oxyacetylene welding technique.
